(19) United States
(12) Patent Application Publication
(10) Pub. No.: US 2020/0349369 A1
(43) Pub. Date: Nov. 5, 2020

(54) METHOD AND APPARATUS FOR TRAINING TRAFFIC SIGN IDENFICATION MODEL, AND METHOD AND APPARATUS FOR IDENTIFYING TRAFFIC SIGN

(71) Applicant: BAIDU ONLINE NETWORK TECHNOLOGY (BEIJING) CO., LTD., Beijing (CN)

(72) Inventors: Yan LIU, Beijing (CN); Yang WANG, Beijing (CN)

(73) Assignee: BAIDU ONLINE NETWORK TECHNOLOGY (BEIJING) CO., LTD.

(21) Appl. No.: 16/811,121

(22) Filed: Mar. 6, 2020

(30) Foreign Application Priority Data
Apr. 30, 2019 (CN) 201910362985.5

(51) Int. Cl. G06K 9/00; G06K 9/62; G06K 9/46; G06N 20/00

(52) U.S. Cl. CPC G06K 9/00818; G06N 20/00; G06K 9/4633; G06K 9/6256

(57) ABSTRACT

Embodiments of the present disclosure relate to a method and apparatus for training a traffic sign identification model, and a method and apparatus for identifying a traffic sign. The method for training a traffic sign identification model includes: obtaining an original image containing a traffic sign; generating a target image based on the original image through a machine learning model, in which the machine learning model is trained based on a plurality of pairs of sample images, each pair contains an original sample image containing the traffic sign and a modified sample image after modifying the original sample image; and training the traffic sign identification model based at least on the target image.

### CROSS-REFERENCE TO RELATED APPLICATION

The present application is based upon and claims priority to Chinese Patent Application No. 201910362985.5, filed on Apr. 30, 2019, the entirety contents of which are incorporated herein by reference.

### TECHNICAL FIELD

The present disclosure generally relates to the field of automatic or assisted driving, and more particularly, to a method and apparatus for training a traffic sign identification model, and a method and apparatus for identifying a traffic sign.

### BACKGROUND

Traffic sign identification is one of the core functions of autonomous driving, assisted driving or unmanned vehicles, which directly affects the safety of passengers and pedestrians. Currently, traffic sign is usually identified by neural networks, the data sets of which rely on open source data sets and manual collection, and thus the amount of data is extremely limited. The lack of training samples easily leads to overfitting of the neural network due to severe shortage of traffic sign data, which greatly affects the effect of traffic sign identification.

Therefore, a solution for training a traffic sign identification model is required to at least partially solve the above technical problems.

### SUMMARY

Embodiments of the present disclosure provide a solution relating to a traffic sign identification model.

In an embodiment of the present disclosure, a method for training a traffic sign identification model is provided. The method includes: obtaining an original image containing a traffic sign; generating a target image based on the original image through a machine learning model, in which the machine learning model is trained based on a plurality of pairs of sample images, each pair contains an original sample image containing a traffic sign and a modified sample image after modifying the original sample image; and training the traffic sign identification model based on at least the target image.

In an embodiment of the present disclosure, a method for identifying a traffic sign is provided. The method includes: obtaining an image to be identified; and identifying the image to be identified by a traffic sign identification model, in which the traffic sign identification model is trained by performing acts of: obtaining an original image containing a traffic sign; generating a target image based on the original image through a machine learning model, in which the machine learning model is trained based on a plurality of pairs of sample images, each pair contains an original sample image containing the traffic sign and a modified sample image after modifying the original sample image; and training the traffic sign identification model based at least on the target image.

In an embodiment of the present disclosure, an apparatus for training a traffic sign identification model is provided. The apparatus includes: one or more processors; a memory storing instructions executable by the one or more processors; in which the one or more processors are configured to: obtain an original image containing a traffic sign; generate a target image based on the original image through a machine learning model, in which the machine learning model is trained based on a plurality of pairs of sample images, each pair contains an original sample image containing a traffic sign and a modified sample image after modifying the original sample image; and train the traffic sign identification model based on at least the target image.

In an embodiment of the present disclosure, an apparatus for identifying a traffic sign is provided. The apparatus includes: one or more processors; a memory storing instructions executable by the one or more processors; in which the one or more processors are configured to: obtain an image to be identified; and identify the image to be identified by a traffic sign identification model, in which the traffic sign identification model is trained by performing acts of: obtaining an original image containing a traffic sign; generating a target image based on the original image through a machine learning model, in which the machine learning model is trained based on a plurality of pairs of sample images, each pair contains an original sample image containing the traffic sign and a modified sample image after modifying the original sample image; and training the traffic sign identification model based at least on the target image.

It should be understood that what is described in the Summary section is not intended to limit key or important features of the embodiments of the present disclosure, nor is it intended to limit the scope of the present disclosure. Additional features of the present disclosure will become readily understood from the following description.

### BRIEF DESCRIPTION OF THE DRAWINGS

The above and/or additional features, advantages, and aspects of embodiments of the present disclosure will become apparent and more readily appreciated from the following descriptions made with reference to the drawings, the same or similar reference numerals denote the same or similar elements, in which:

FIG. 1 is a block diagram of an exemplary environment in which embodiments of the present disclosure can be implemented.

FIG. 2A is a flowchart of a method for training a traffic sign identification model according to some embodiments of the present disclosure.

FIG. 2B is a flowchart of a method for identifying a traffic sign according to some embodiments of the present disclosure.

FIG. 3 is a schematic diagram for training an adversary generation network according to some embodiments of the present disclosure.

FIG. 4 is a schematic diagram for training an adversary generation network according to some embodiments of the present disclosure.

FIG. 5A is a block diagram of an apparatus for training a traffic sign identification model according to some embodiments of the present disclosure.

FIG. 5B is a block diagram of an apparatus for identifying a traffic sign according to some embodiments of the present disclosure.

FIG. 6 is a block diagram of an electronic device capable of implementing some embodiments of the present disclosure.

### DETAILED DESCRIPTION

Embodiments of the present disclosure will be described in detail in the drawings. Although the drawings illustrate certain embodiments of the present disclosure, it should be understood that the present disclosure may be implemented in various forms and should not be construed as limited to the embodiments set forth herein, but rather these embodiments are provided for understanding the present disclosure more thorough and complete. It should be understood that the drawings and embodiments of the present disclosure are for exemplary purposes only, and are not intended to limit the protection scope of the present disclosure.

As mentioned above, currently, the lack of data set easily leads to overfitting of the traffic sign identification model. In addition, although regulations on the style and specifications of traffic are uniform nationally, local implementations are different, the styles of traffic signs are diverse, which are not included fully in the existing data set. In addition, there are various deviations between the actual environment and the ideal traffic sign, which seriously affects the identification effect.

In view of the above problems and other possible potential problems, embodiments of the present disclosure provide a solution for training a traffic sign identification model. In this solution, a target image is generated based on an original image through a machine learning model, in which the machine learning model is trained based on a plurality of pairs of sample images. Each pair of the plurality of pairs of sample images includes an original sample image containing a traffic sign and a modified sample image after modifying the original sample image. The target image can be used to train a traffic sign identification model. In this way, sufficient training data can be obtained to train the traffic sign identification model, thereby avoiding the phenomenon of overfitting. Here, the “traffic sign” is also referred to as a traffic sign plate, which is a sign indicating traffic rules on both sides of a road or at various locations on the road, such as turning left, turning right, go straight, and speed limit.

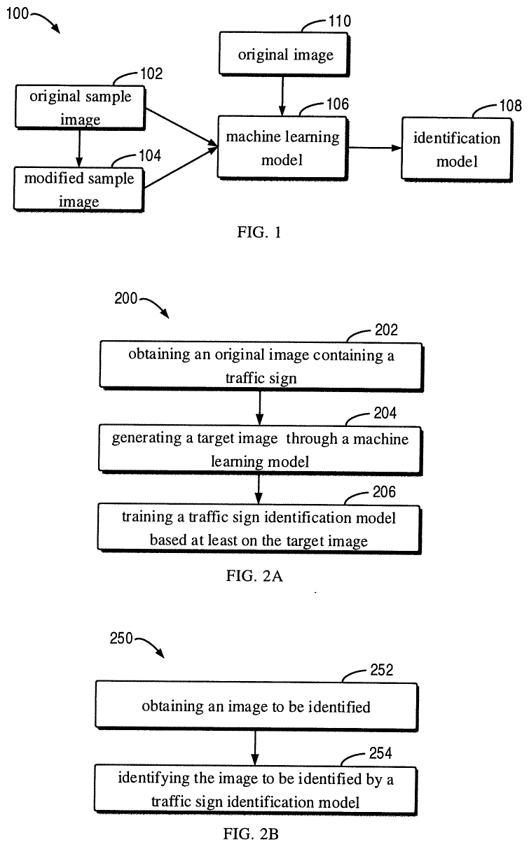

The embodiments disclosed herein are described in detail in combination with FIGS. 1-4 below. FIG. 1 is a block diagram of an exemplary environment 100 in which embodiments of the present disclosure can be implemented. As illustrated in FIG. 1, an original sample image 102 may be a real captured image of a traffic sign, or a design image of a traffic sign. The original sample image 102 may be modified to generate a modified sample image 104. For example, one or more aspects, such as lighting (illumination), shooting angle, shooting distance, definition, and occlusion (shading or sheltering), of the original sample image 102 may be modified to generate the modified sample image 104. In some embodiments, the original sample image 102 can be modified automatically by a computer program, for example, OpenCV may be used to assist the modification. Alternatively, the original sample image 102 can also be modified manually to increase flexibility.

The original sample image 102 and the modified sample image 104 may be provided to a machine learning model 106 for training. The trained machine learning model 106 can know the mapping relation between the original sample image 102 and the modified sample image 104. In this manner, the original image 110 of the traffic sign is provided to the machine learning model 106. The machine learning model 106 acquires a modified image corresponding to the original image 110, which is also referred to as a target image. The target image is provided to an identification model 108 for training. The identification model 108 may be a multi-classification model that identifies received images to determine a type of a traffic sign. The original image 110 may also be provided to the identification model 108 together with the target image to train the identification model 108.

FIG. 2A is a flowchart of a method 200 for training a traffic sign identification model according to some embodiments of the present disclosure. The method 200 is described below with reference to the exemplary environment 100 of FIG. 1. However, it should be understood that the method 200 can also be applied for any suitable environments other than the exemplary environment 100 shown in FIG. 1.

At block 202, an original image 110 containing a traffic sign is obtained. The original image may be obtained by various methods, for example, an image of a traffic sign around a road which is captured while a vehicle is in motion, or a frame of a video, may be used as the original image.

At block 204, a target image is generated based on the original image 110 through a machine learning model 106. The machine learning model 106 is trained based on a plurality of pairs of sample images, each pair of sample images contains an original sample image 102 containing the traffic sign and a modified sample image 104 after modifying the original sample image 102. Through training, the machine learning model 106 may represent a mapping relation between the original sample image 102 and the modified sample image 104. The target image is obtained by applying the mapping relation on the original image 110. The original sample image 102 can be modified in one or more ways to obtain the modified sample image 104, which is described in detail below in combination with some embodiments.

In an embodiment, the modified sample image 104 is obtained by modifying a shooting angle of the original sample image 102. For example, the shooting angle of the original sample image 102 may be shifted by a certain angle, such that the images containing the traffic sign is captured at various angles.

In an embodiment, the modified sample image 104 is obtained by modifying an illumination of the original sample image 102. For example, the original sample image 102 may be captured under a good lighting condition, so that the lighting condition of the original sample image 102 may be modified to poor lighting conditions to obtain the modified sample image 104.

In an embodiment, the modified sample image 104 is obtained by modifying a shooting distance of the original sample image 102. For example, the shooting distance of the original sample image 102 may be relatively short. However, it is desirable to identify the image at a long distance so that the automatic vehicle can give a better judgment, especially when the vehicle is traveling at a high speed.

In an embodiment, the modified sample image 104 is obtained by modifying a definition of the original sample image 102. For example, the original sample image 102 may be a high-definition image, and the definition of the original sample image 102 may be reduced to obtain the modified sample image 104.

In an embodiment, the modified sample image 104 is obtained by applying random occlusions to the original sample image 102. For example, the occlusion effect can be simulated by adjusting some pixels in the original sample image 102 to black. Traffic signs may be blocked or sheltered in many ways, for example, by small advertisement stickers, or eroding by rain erosion. The sample image 104 can be modified to simulate these occlusion situations to increase the diversity of the samples.

Several embodiments of modifying the original sample image 102 in one or more aspects have been described above. It should be understood that these embodiments are not mutually exclusive, but can be combined with each other to produce further new embodiments.

In some embodiment, the machine learning model 106 may be an adversary generation network, such as a deep convolutional generative adversary generation network. The adversary generation network includes a generator and a discriminator. The generator may be based on a deep deconvolution network, and the discriminator may be based on a deep convolution network. In an embodiment of the adversary generation network, a target image may be generated by the generator 304 based on the original image 110.

In the adversary generation network, the samples generated by the generator are called fake samples, and the real samples are called true samples. The discriminator is responsible for determining whether an input sample is a true sample or a fake sample. The training goal of the generator is to generate realistic samples until the discriminator can be deceived with the samples. The training goal of the discriminator is to distinguish true from fake as far as possible. After training by the adversary generation network, the generator can generate a large number of samples that are very close to the modified sample image, and can even trick the discriminator.

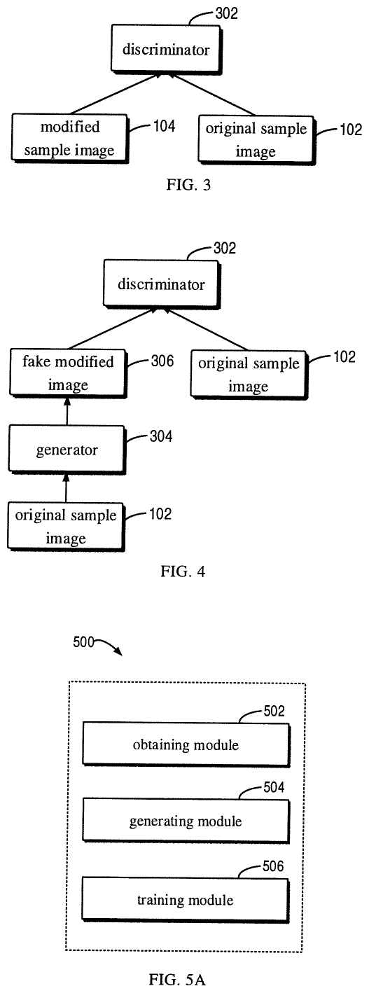

The embodiments of the adversary generation network are described below with reference to FIGS. 3-4, wherein FIG. 3 shows a case of true samples, and FIG. 4 shows a case of fake samples.

As illustrated in FIG. 3, a discriminator 302 receives the original sample image 102 and the modified sample image 104, and determines whether there is a correspondence between the two images. In this case, the training goal of the discriminator 302 is to determine that there is a corresponding relation between the two images.

As illustrated in FIG. 4, the generator 304 generates a fake modified image 306 based on the original sample image 102. The discriminator 302 receives the fake modified sample image 306 and the original sample image 102 and determines whether there is a correspondence between the two images. In this case, the training goal of the discriminator 302 is to determine that there is no correspondence between the two images, and the training goal of the generator 304 is to make the discriminator 302 incorrectly determines that there is a corresponding relation between the two images as far as possible.

At block 206, the traffic sign identification model 108 is trained based at least on the target image. For example, the target image may be added to a training set of the traffic sign identification model 108 and used together with other images to train the traffic sign identification model 108. The traffic sign identification model 108 may be a neural network model, such as a deep neural network model. The traffic sign recognition model 108 may be trained using any suitable method currently known or developed in the future, such as stochastic gradient descent (SGD) method and the like.

FIG. 2B is a flowchart of a method 250 for identifying a traffic sign according to some embodiments of the present disclosure. The method 250 is described below in combination with the exemplary environment 100 of FIG. 1, however, it should be understood that the method 250 can also be applied to any suitable environments other than the exemplary environment 100 shown in FIG. 1.

At block 252, an image to be identified is obtained. The image to be identified may be an image or a frame of a video collected in real time by an automatic vehicle. The image to be identified may be processed locally in the vehicle, or it can be transferred to the cloud for processing in the cloud.

At block 254, the image to be identified is identified by the traffic sign identification model 108. The traffic sign identification model 108 may be trained according to the method 200 shown in FIG. 2A. In this way, the type of the traffic sign in the image to be identified can be determined.

The embodiments of the present disclosure can effectively overcome the severe shortage of traffic sign data, and the lack of training samples which leads to overfitting of the network, and effectively enhance the data samples, also improves the generalization and robustness of the traffic sign identification network, thereby overcoming the impact of different angles, lighting, distances, definitions, rain erosion, and occultation by small advertising sticker on the identification, and improving the identification rate of traffic signs. Therefore, the embodiments have high practical value.

FIG. 5A is a block diagram of an apparatus 500 for training a traffic sign identification model according to some embodiments of the present disclosure. The apparatus 500 may be used to implement the method 200 shown in FIG. 2A.

The apparatus 500 includes an obtaining module 502, configured to obtain an original image containing a traffic sign; and a generating module 504, configured to generate a target image based on the original image through a machine learning model, in which the machine learning model is trained based on a plurality of pairs of sample images, each pair contains an original sample image containing a traffic sign and a modified sample image after modifying the original sample image.

In some embodiments, the modified sample image paired with the original sample image is obtained by performing at least one of: modifying a shooting angle of the original sample image; modifying a lighting of the original sample image; modifying a shooting distance of the original sample image; modifying a definition of the original sample image; and applying random occlusions to the original sample image.

In some embodiments, the machine learning model includes an adversary generation network. In some embodiments, the adversary generation network includes a generator and a discriminator, and the adversary generation network is trained by: generating a fake modified image based on the original sample image by the generator; and training the adversary generation network by using a plurality of pairs of sample images as true samples and using a pair of the original sample image and the fake modified image as fake samples.

In some embodiments, the generating module 204 includes: a generator module, configured to generate the target image by the generator based on the original image.

The device 500 includes a training module 506, configured to train a traffic sign identification model based at least on the target image.

FIG. 5A is a block diagram of an apparatus 550 for training a traffic sign identification model according to some embodiments of the present disclosure. The apparatus 550 may be used to implement the method 250 in FIG. 2B.

As illustrated in FIG. 5B, the apparatus 550 includes an image-to-be-identified acquisition module 552, configured to obtain an image to be identified; and an identifying module 554, configured to identify the image to be identified by a traffic sign identification model, wherein the traffic sign identification model is trained through the method 200 as illustrated in FIG. 2A.

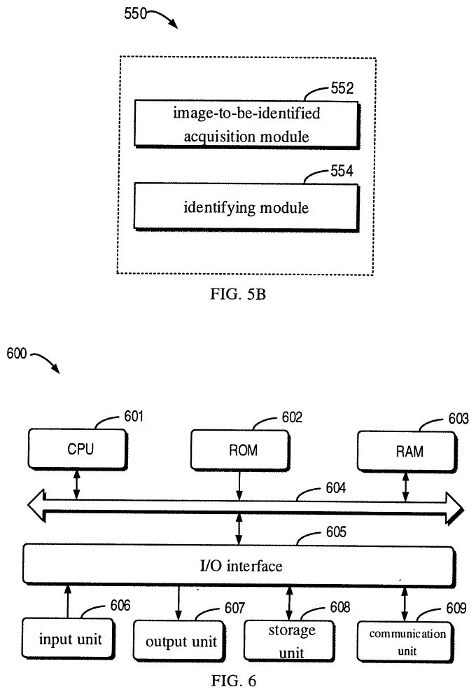

FIG. 6 is a block diagram of an electronic device 600 capable of implementing some embodiments of the present disclosure. The exemplary environment 100 shown in FIG. 1 and the apparatus 500 shown in FIG. 5 may be implemented by the device 600. As shown in FIG. 6, the device 600 includes a central processing unit (CPU) 601 that performs various appropriate actions and processes according to computer program instructions stored in a read-only memory (ROM) 602 or computer program instructions loaded into a random access memory (RAM) 603 from a storage unit 608. In the RAM 603, various programs and data required for the operation of the device 600 can also be stored. The CPU 601, the ROM 602, and the RAM 603 are connected to each other through a bus 604. An input/output (I/O) interface 605 is also connected to a bus 604.

Components in the device 600 are connected to the I/O interface 605, including: an input unit 606, such as a keyboard, a mouse; an output unit 607, such as various types of displays, speakers; a storage unit 608, such as a disk, an optical disk; and a communication unit 609, such as network cards, modems, wireless communication transceivers, and the like. The communication unit 609 allows the device 600 to exchange information/data with other devices through a computer network such as the Internet and/or various telecommunication networks.

The various processes described above, such as the method 200, may be performed by the processing unit 601. For example, in some embodiments, the method 200 may be implemented as a computer software program that is tangibly embodied on a machine-readable medium, such as the storage unit 608. In some embodiments, part or all of the computer program may be loaded and/or installed on the device 600 via the ROM 602 and/or the communication unit 609. When a computer program is loaded into the RAM 603 and executed by the CPU 601, one or more steps of the method 200 described above may be performed. Alternatively, in other embodiments, the CPU 601 may be configured to perform the method 200 by any other suitable means (e.g., by means of firmware).

The present disclosure may be a method, device, system, and/or computer program product. The computer program product may include a computer-readable storage medium on which computer-readable program instructions for performing various aspects of the present disclosure are loaded.

A computer-readable storage medium may be a tangible device that can hold and store instructions used by the instruction execution device. The computer-readable storage medium may be, for example, but not limited to, an electric storage device, a magnetic storage device, an optical storage device, an electromagnetic storage device, a semiconductor storage device, or any suitable combination of the foregoing. More specific examples (non-exhaustive list) of computer-readable storage media include: portable computer disks, hard disks, random access memory (RAM), read-only memory (ROM), erasable programmable read-only memory (EPROM or flash memory), static random access memory (SRAM), portable compact disc read-only memory (CD-ROM), digital versatile disc (DVD), memory stick, floppy disk, mechanical encoding device, a protruding structure in the hole card or groove with instructions-stored thereon, and any suitable combination of the above. Computer-readable storage media used herein are not to be interpreted as transient signals per se, such as radio waves or other freely propagating electromagnetic waves, electromagnetic waves propagating through waveguides or other transmission media (for example, light pulses through fiber optic cables), or electrical signal transmitted via electrical wires.

The computer-readable program instructions described herein can be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or one or more source code or object code written in any combination of programming languages, including object-oriented programming languages—such as Smalltalk, C++, and conventional procedural programming languages—such as “C” or similar programming languages. Computer-readable program instructions may be executed entirely on the user's computer, partly on the user's computer, as a stand-alone software package, partly on the user's computer and partly on a remote computer, or entirely on a remote computer or server. In the case of a remote computer, the remote computer can be connected to the user's computer through any kind of networks, including local area networks (LAN) or wide area networks (WAN), or it can be connected to an external computer (such as through the Internet by an internet service provider). In some embodiments, the electronic circuit is personalized by using the state information of the computer-readable program instructions, such as a programmable logic circuit, a field programmable gate array (FPGA), or a programmable logic array (PLA). The electronic circuit may execute computer-readable program instructions to implement various aspects of the present disclosure.

Various aspects of the present disclosure are described herein with reference to flowcharts and/or block diagrams of methods, devices (systems) and computer program products according to embodiments of the present disclosure. It should be understood that each block of the flowcharts and/or block diagrams, and combinations of blocks in the flowcharts and/or block diagrams, can be implemented by computer-readable program instructions.

These computer-readable program instructions can be provided to a processing unit of a general-purpose computer, special-purpose computer, or other programmable data processing device, thereby producing a machine such that when these instructions are processed by the processing units of a computer or other programmable data processing device, a device for implementing the functions/actions specified in one or more blocks in the flowcharts and/or block diagrams is generated. These computer-readable program instructions may also be stored in a computer-readable storage medium, and these instructions cause a computer, a programmable data processing apparatus, and/or other devices to work in a specific manner. Thus, a computer-readable medium storing instructions includes: an article of manufacture that includes instructions to implement various aspects of the functions/acts specified in one or more blocks in the flowchart and/or block diagram.

The computer-readable program instructions may also be loaded on a computer, other programmable data processing device, or other device, so that a series of operation steps are performed on the computer, other programmable data processing device, or other device to generate a computer implementation process, so that instructions executed on a computer, other programmable data processing device, or other device implement the functions/actions specified in one or more blocks in the flowchart and/or block diagram.

The flowchart and block diagrams in the figures show the architecture, functionality, and operation of possible implementations of systems, methods and computer program products according to various embodiments of the present disclosure. In this regard, each block in the flowchart or block diagram may represent a module, a program segment, or a part of an instruction that contains one or more executable instructions for implementing a specified logical function. In some alternative implementations, the functions marked in the blocks may also occur in a different order than those marked in the drawings. For example, two consecutive blocks may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented in a dedicated hardware-based system that performs the specified function or action, or it can be implemented with a combination of dedicated hardware and computer instructions.

The embodiments of the present disclosure have been described above, the above description is exemplary, not exhaustive, and is not limited to the disclosed embodiments. Many modifications and variations will be apparent to those skilled in the art without departing from the scope and spirit of the various embodiments described. The terminology used herein is chosen to best explain the principles of the embodiments, practical applications or improvements to the technology in the market, or to enable others to understand the embodiments disclosed herein.

What is claimed is:

1. A method for training a traffic sign identification model, comprising:
obtaining an original image containing a traffic sign;
generating a target image based on the original image through a machine learning model, wherein the machine learning model is trained based on a plurality of pairs of sample images, each pair contains an original sample image containing the traffic sign and a modified sample image after modifying the original sample image; and
training the traffic sign identification model based at least on the target image.

2. The method according to claim 1, wherein the modified sample image paired with the original sample image is obtained by performing at least one of:
modifying a shooting angle of the original sample image;
modifying a lighting of the original sample image;
modifying a shooting distance of the original sample image;
modifying a definition of the original sample image; and
applying random occlusions to the original sample image.

3. The method according to claim 1, wherein the machine learning model comprises an adversary generation network.

4. The method according to claim 3, wherein the adversary generation network comprises a generator and a discriminator, and the adversary generation network is trained by:
generating a fake modified image based on the original sample image by the generator; and
training the adversary generation network by using the plurality of pairs of sample images as true samples and using a pair of the original sample image and the fake modified image as fake samples.

5. The method according to claim 4, wherein generating the target image comprises:
generating the target image from the original image by the generator.

6. The method according to claim 1, wherein the machine learning model represents a mapping relation between the original sample image and the modified sample image, and generating the target image comprises: generating the target image based on the original image according to the mapping relation.

7. A method for identifying a traffic sign, comprising:
obtaining an image to be identified; and
identifying the image to be identified by a traffic sign identification model, wherein the traffic sign identification model is trained by performing acts of:
obtaining an original image containing a traffic sign;
generating a target image based on the original image through a machine learning model, wherein the machine learning model is trained based on a plurality of pairs of sample images, each pair contains an original sample image containing the traffic sign and a modified sample image after modifying the original sample image; and
training the traffic sign identification model based at least on the target image.

8. An apparatus for training a traffic sign identification model, comprising:
one or more processors;
a memory storing instructions executable by the one or more processors;
wherein the one or more processors are configured to:
obtain an original image containing a traffic sign;
generate a target image based on the original image through a machine learning model, wherein the machine learning model is trained based on a plurality of pairs of sample images, each pair contains an original sample image containing the traffic sign and a modified sample image after modifying the original sample image; and
train the traffic sign identification model based at least on the target image.

9. The apparatus according to claim 8, wherein the modified sample image paired with the original sample image is obtained by performing at least one of:
modifying a shooting angle of the original sample image;
modifying a lighting of the original sample image;
modifying a shooting distance of the original sample image;
modifying a definition of the original sample image; and
applying random occlusions to the original sample image.

10. The apparatus according to claim 8, wherein the machine learning model comprises an adversary generation network.

11. The apparatus according to claim 10, wherein the adversary generation network comprises a generator and a discriminator, and the adversary generation network is trained by:
generating a fake modified image based on an original sample image by a generator; and
training the adversary generation network by using the plurality of pairs of sample images true samples and using a pair of the original sample image and the fake modified image as fake samples.

12. The apparatus according to claim 11, wherein the one or more processors are configured to:
generate the target image from the original image by the generator.

13. The apparatus according to claim 8, wherein the machine learning model represents a mapping relation between the original sample image and the modified sample image, and the one or more processors are configured to generate the target image based on the original image according to the mapping relation.
